(19) United States
(12) Patent Application Publication
(10) Pub. No.: US 2010/0066561 A1
(43) Pub. Date: Mar. 18, 2010

(54) SENSOR TRANSPONDER UNIT AND METHOD FOR OPERATING IT

(75) Inventors: Keith Ulrich, Bonn-Oberkassel (DE); Stefan Wilms, Köln (DE)

Correspondence Address: International IP Law Group, P.O. BOX 691927, HOUSTON, TX, 77269-1927, US

(73) Assignee: Deutsche Post AG, Bonn (DE)

(21) Appl. No.: 12/517,684

(22) PCT Filed: Dec. 4, 2007
(86) PCT No.: PCT/EP2007/010515

§ 371 Date: Oct. 6, 2009

(30) Foreign Application Priority Data
Dec. 5, 2006 (DE) 10 2006 057 645.4

(51) Int. Cl. H04Q 9/00; H04Q 5/22

(52) U.S. Cl. 340/870.07; 340/10.1

(57) ABSTRACT

There is provided a sensor-transponder unit. An exemplary sensor-transponder unit comprises a sensor. The exemplary sensor-transponder unit also comprises a transponder connected to the sensor by a connection element. The sensor and the transponder are configured as components that are physically separated from each other. The exemplary sensor-transponder unit additionally comprises an interlayer that absorbs or reflects electromagnetic radiation arranged between the sensor and the transponder.

### CROSS REFERENCE TO RELATED APPLICATIONS

Pursuant to 35 U.S.C. §371, this application is the United States National Stage Application of International Patent Application No. PCT/EP2007/010515, filed on Dec. 4, 2007, the contents of which are incorporated by reference as if set forth in their entirety herein, which claims priority to German (DE) Patent Application No. 10 2006 057 645.4, filed Dec. 5, 2006, the contents of which are incorporated by reference as if set forth in their entirety herein.

### BACKGROUND

It is a known procedure to use sensor-transponder units for monitoring purposes. The prior-art sensor-transponder units consist of a uniform module that contains a sensor, a transponder, a computing unit, a memory unit and a battery.

### SUMMARY OF THE INVENTION

Exemplary embodiments of the present invention relate to a sensor-transponder unit and a method for operating the sensor-transponder unit.

A sensor-transponder unit according to an exemplary embodiment of the present invention can be used in various technological fields as flexibly as possible.

An especially advantageous use of the sensor-transponder unit according to an exemplary embodiment of the present invention provides for placing it in a container, especially a container for transportation processes, in a logistics system.

A refinement of the sensor-transponder unit, of the method for its operation, of the container and of the use of the sensor-transponder unit according to an exemplary embodiment of the present invention is characterized in that the transponder and the sensor are configured as components that are physically separated from each other.

A refinement of the sensor-transponder unit, of the method for its operation, of the container and of the use of the sensor-transponder unit according to an exemplary embodiment of the present invention provides that the transponder and the sensor are located in two housings that are separate from each other.

A refinement of the sensor-transponder unit, of the method for its operation, of the container and of the use of the sensor-transponder unit according to an exemplary embodiment of the present invention is characterized in that the transponder and the sensor are connected to each other by a connection element (V).

A refinement of the sensor-transponder unit, of the method for its operation, of the container and of the use of the sensor-transponder unit according to an exemplary embodiment of the present invention provides that it can be connected to a container, whereby the container has an interior to hold at least one object.

A refinement of the sensor-transponder unit, of the method for its operation, of the container and of the use of the sensor-transponder unit according to an exemplary embodiment of the present invention is characterized in that the sensor is located in the interior of the container.

A refinement of the sensor-transponder unit, of the method for its operation, of the container and of the use of the sensor-transponder unit according to an exemplary embodiment of the present invention provides that the transponder is arranged further to the outside than the sensor is.

A refinement of the sensor-transponder unit, of the method for its operation, of the container and of the use of the sensor-transponder unit according to an exemplary embodiment of the present invention is characterized in that the transponder and the sensor are connected to each other by at least one cable.

A refinement of the sensor-transponder unit, of the method for its operation, of the container and of the use of the sensor-transponder unit according to an exemplary embodiment of the present invention provides that the transponder and the sensor are connected to each other by an electromagnetic coupling means.

A refinement of the sensor-transponder unit, of the method for its operation, of the container and of the use of the sensor-transponder unit according to an exemplary embodiment of the present invention is characterized in that measured data about the object is acquired by a sensor, in that the acquired measured values are transmitted to a transponder, and in that the transponder transmits status information to a reading unit as a function of the measured data.

A refinement of the sensor-transponder unit, of the method for its operation, of the container and of the use of the sensor-transponder unit according to an exemplary embodiment of the present invention provides that the status information is stored.

A refinement of the sensor-transponder unit, of the method for its operation, of the container and of the use of the sensor-transponder unit according to an exemplary embodiment of the present invention is characterized in that the status information is stored in a storage medium installed in the container.

A refinement of the sensor-transponder unit, of the method for its operation, of the container and of the use of the sensor-transponder unit according to an exemplary embodiment of the present invention provides that the connection element comprises at least one optical waveguide.

A refinement of the sensor-transponder unit, of the method for its operation, of the container and of the use of the sensor-transponder unit according to an exemplary embodiment of the present invention is characterized in that the sensor is closer to the object than the transponder is.

A refinement of the sensor-transponder unit, of the method for its operation, of the container and of the use of the sensor-transponder unit according to an exemplary embodiment of the present invention provides that the interlayer has a shock-absorbing effect.

A refinement of the sensor-transponder unit, of the method for its operation, of the container and of the use of the sensor-transponder unit according to an exemplary embodiment of the present invention is characterized in that the interlayer absorbs electromagnetic radiation.

A refinement of the sensor-transponder unit, of the method for its operation, of the container and of the use of the sensor-transponder unit according to an exemplary embodiment of the present invention provides that the interlayer reflects electromagnetic radiation.

A refinement of the sensor-transponder unit, of the method for its operation, of the container and of the use of the sensor-transponder unit according to an exemplary embodiment of the present invention is characterized in that a sensor of the sensor-transponder unit acquires measured data and transmits it via a connection structure (V) to the transponder (T), and in that the transponder transmits status information to a reading unit while influencing the measured data.

A refinement of the sensor-transponder unit, of the method for its operation, of the container and of the use of the sensor-transponder unit according to an exemplary embodiment of the present invention provides that energy is supplied to the transponder.

Furthermore, it is advantageous to arrange at least one interlayer between the sensor and the transponder.

A refinement of the sensor-transponder unit, of the method for its operation, of the container and of the use of the sensor-transponder unit according to an exemplary embodiment of the present invention is characterized in that the energy is supplied by a reading unit.

A refinement of the sensor-transponder unit, of the method for its operation, of the container and of the use of the sensor-transponder unit according to an exemplary embodiment of the present invention provides that the energy is relayed from the transponder to the sensor.

A refinement of the sensor-transponder unit, of the method for its operation, of the container and of the use of the sensor-transponder unit according to an exemplary embodiment of the present invention is characterized in that a signal line is established between the sensor and the transponder by a connection element.

A refinement of the container, of the method for producing the container, of the logistics system and of the use of the container according to an exemplary embodiment of the present invention provides that the container is transported from a sending location to a receiving location.

A refinement of the container, of the method for producing the container, of the logistics system and of the use of the container according to an exemplary embodiment of the present invention is characterized in that the logistics system has a reader that interacts with at least one transponder arranged in the container in such a way that measured data about the object acquired by a sensor is transmitted to a reading unit.

A refinement of the container, of the method for producing the container, of the logistics system and of the use of the container according to an exemplary embodiment of the present invention provides that the position of the container is determined and that the position of the container is associated with the status information obtained from the sensor.

A refinement of the container, of the method for producing the container, of the logistics system and of the use of the container according to an exemplary embodiment of the present invention is characterized in that energy is supplied to the transponder.

A refinement of the container, of the method for producing the container, of the logistics system and of the use of the container according to an exemplary embodiment of the present invention provides that the energy is supplied by means of the reading unit.

A refinement of the container, of the method for producing the container, of the logistics system and of the use of the container according to an exemplary embodiment of the present invention is characterized in that the energy is relayed from the transponder to the sensor.

A refinement of the container, of the method for producing the container, of the logistics system and of the use of the container according to an exemplary embodiment of the present invention provides that a signal line is established between the sensor and the transponder by a connection element.

An exemplary embodiment of the invention provides for an element comprising at least one transponder and at least one sensor to be connected to the packaging. A fixed connection to the packaging makes it possible to improve the entire method and offers the possibility of certification. The RFID component, which allows contact-free reading (important for refrigerated transports: the temperature information can be read without having to open the packaging!), should be located directly behind the outer wall but should be protected. The temperature sensor should be as close to the product as possible, that is to say, should be fastened as close as possible to the center of the interior of the packaging. The sensor elements and the RFID are preferably connected to each other via a serial connection, in this case via two flexible wires.

A refinement of an exemplary embodiment of the present invention provides for distributing and connecting several identical temperature sensors in the packaging so that the temperature characteristics in the packaging can be ascertained more accurately. Moreover, other or additional sensors can be installed that can perhaps measure humidity or vibration. In any case, the electronics should be incorporated into the packaging unit as invisibly as possible. An option is for the electronic components to be finely intermeshed within the packaging. This intermeshing (embedding) is preferably carried out during a production process of the packaging.

A refinement of the sensor-transponder unit, of the method for its operation, of the container and of the use of the sensor-transponder unit according to an exemplary embodiment of the present invention is characterized in that a position of the transponder is determined.

A refinement of the sensor-transponder unit, of the method for its operation, of the container and of the use of the sensor-transponder unit according to an exemplary embodiment of the present invention provides that the position of the container is stored.

A refinement of the sensor-transponder unit, of the method for its operation, of the container and of the use of the sensor-transponder unit according to an exemplary embodiment of the present invention is characterized in that the position is stored in the data processing unit.

A refinement of the sensor-transponder unit, of the method for its operation, of the container and of the use of the sensor-transponder unit according to an exemplary embodiment of the present invention provides that the position of the container is determined and that the position of the container is associated with the status information obtained from the sensor.

A refinement of the sensor-transponder unit, of the method for its operation, of the container and of the use of the sensor-transponder unit according to an exemplary embodiment of the present invention is characterized in that energy is supplied to the transponder.

A refinement of the sensor-transponder unit, of the method for its operation, of the container and of the use of the sensor-transponder unit according to an exemplary embodiment of the present invention provides that the energy is supplied by a reading unit.

A refinement of the sensor-transponder unit, of the method for its operation, of the container and of the use of the sensor-transponder unit according to an exemplary embodiment of the present invention is characterized in that the energy is relayed from the transponder to the sensor.

A refinement of the sensor-transponder unit, of the method for its operation, of the container and of the use of the sensor-transponder unit according to an exemplary embodiment of the present invention provides that a signal line is established between the sensor and the transponder by a connection element.

A refinement of the sensor-transponder unit, of the method for its operation, of the container and of the use of the sensor-transponder unit according to an exemplary embodiment of the present invention is characterized in that the connection element comprises at least one wire.

Many types of transponders are suitable for use according to an exemplary embodiment of the present invention. Special preference is given to transponders that serve as transmitting and/or receiving devices. In particular, these are receiving devices that, after receiving an external signal, are capable of transmitting a signal of their own.

Special preference is given to the use of transponders that are provided with at least one identifier. Below, such transponders are also referred to as RFID tags.

It is advantageous to replace or augment a visually detectable identification of objects in transportation or logistics systems using RFID technologies involving transponders that can be written and read electronically multiple times. Such systems have the advantage that a great deal of information can be electronically written into and read out of a transponder, as a result of which automatic transportation, sorting, tracking or distribution procedures can be controlled without information having to be displayed visually.

Preferably, transponders are configured with identifiers (RFID tags). An RFID tag consists of a microchip and an antenna. A code containing processing-relevant information is stored on the chip. In one exemplary embodiment of the present invention, this information is identification information (ID).

Transponders may be configured in such a way that, in response to a triggering (radio) signal from a reading device, they themselves transmit and/or receive signals. Active transponders contain a source of energy for their operation. In contrast, passive transponders may obtain energy from the signals transmitted by the reading device.

The method according to an exemplary embodiment of the present invention for monitoring a container for holding objects provides that a sensor in the interior serves to detect status changes in the physical properties of the contents of the container.

Subsequently, the measured data is transmitted to the transponder.

The transponder transmits status information to a reading unit as a function of the measured data.

In a first exemplary embodiment, the measured data itself is transmitted as status information to the reading unit.

In another, likewise advantageous embodiment, critical parameters derived from the measured data—for example, exceeding of the temperature—are transmitted.

The transmission of selected, compressed and/or reduced values has the advantage that storage and transmission capacities can be utilized more efficiently.

Numerous types of reading devices are possible when transponders are used for relaying the measured values.

Antennas may be used that are tuned to the specific wavelength of the electromagnetic radiation of the transponders.

The possibility of reading several transponders in rapid succession makes certain requirements of the reading unit that is going to be used.

It is especially advantageous for the reading unit to be equipped with the BRM function known from the state of the art.

The BRM function (Buffered Read Mode=data filtering and data storage) ensures that the data from transponders that have already been read out are buffered in the reader and is only read out once. This advantage plays a role in applications with bulk recognition (anti-collision) since only “new” transponders are read out each time. Consequently, this increases the data transfer speed.

The information acquired in this manner is subsequently further processed.

Various transmission modalities can be employed for the transmission to the reading unit.

The reading unit is arranged in a transportation system for the container, in a warehouse or in a processing center for the container.

A data processing unit that can preferably be in communication with the reading unit receives this status information from the reading unit.

A refinement of the method according to an exemplary embodiment of the present invention is characterized in that the position of the container is determined by a position-finding device that is in communication with the container, and the position of the container is associated with the status information obtained from the sensor. In this case, the position of the container can be determined by a position-finding device directly on the container or on a transportation system with which the container is being transported. If the position-finding device is situated on an appertaining transportation system, it is preferably in communication with the data processing unit of the container.

The position of the container can be determined, for example, by a position-finding device in the form of a GSM module, a GPS module, and/or a direction-finding transmitter. The various position-finding devices can be used as a function of the required precision of the position determination, whereby they can be used either perpendicularly or in parallel.

A refinement of the method, of the logistics system, of the container, of the network node and of the computer program product according to an exemplary embodiment of the present invention provides that the status information obtained from the sensors is compared to set points, whereby a deviation from a set point is considered as an alarm. The status information is preferably compared in that the measured electrical properties of the conductive layers are compared to a set point of the electrical properties. Here, it can be provided that a deviation of the physical properties of the container material from a set point is not considered as an alarm if the deviation is associated with a position of the container that is stored in the data processing unit as a position in which it is permissible to open the container.

In an exemplary embodiment of the invention, the status information obtained from the sensor is transmitted to a communication module on the container and the communication module transmits the status information to a message-receiving device.

A refinement of an exemplary embodiment of the present invention provides for the use of at least one transponder as the communication module.

The status information can be transmitted from the communication module to the message-receiving device along the transportation route or after the container has reached the destination. Preferably, the status information is only transmitted along the transportation route if a comparison within the data processing unit indicates that a deviation of the status information acquired by the sensors from set points is considered as an alarm.

The determination of the position of the container and the association of the position with the status information obtained from the sensor is preferably carried out in the data processing unit of the container, but this can also be done in the message-receiving device or in the monitoring center.

A refinement of an exemplary embodiment of the present invention also comprises—in addition to a method for monitoring a container—a container having a monitor according to the invention.

The monitor may comprise sensors that are capable of detecting at least one status parameter that is present in the interior of the container.

In one exemplary embodiment, the container comprises a data processing unit and position-finding device that is in communication with the container in order to determine the position of the container.

However, it is especially preferred to use containers that are configured in such a way that they interact with a data processing unit located outside of the container.

For this purpose, it is advantageous to configure at least one transponder as a communication device in such a way that measured values detected by at least one sensor and/or status information derived from the measured values are transmitted to a data processing unit.

Such an exemplary embodiment has the advantage that computation procedures are performed at least partially outside of the container. As a result, it is possible to use little or no storage media inside the container. In particular, it is advantageous to dimension the storage media in such a way that they store identification information and/or information about the presence of an event that needs to be evaluated.

In an exemplary embodiment of the invention, details about the event that needs to be evaluated are stored and/or processed outside of the container.

This not only reduces the requisite storage capacity in the containers, but also has the added advantage that subsequent processing procedures of the shipment are simplified.

Thus, for example, containers whose contents were subject to severe stresses can be diverted out of a given transportation process.

An even more important aspect is the replacement of damaged objects with new objects.

This is especially important in the case of objects whose use at a specific location is particularly crucial. This applies especially to drugs and medical aids.

Preferably, the container has a communication module that is in communication with the data processing unit as well as an atmosphere measuring device such as a temperature and/or moisture sensor. In an exemplary embodiment of the invention, the container also has a protective covering. Moreover, it is advantageous to configure the container with an object detection device for registering at least the number of objects that have been placed into the container.

The method according to an exemplary embodiment of the present invention has the advantage that the state of a container can be comprehensively monitored during the transportation of objects. Techniques for measuring and monitoring the physical properties of a container material and/or of the ambient conditions can be used together with a position-finding device to associate a position of the container with an event that has occurred to said container or with a status. This makes it possible to precisely determine the position and thus to determine, for example, an area of responsibility in which an event has occurred.

### BRIEF DESCRIPTION OF THE DRAWINGS

The figures show the following:

FIG. 1a is a schematic depiction of a sensor-transponder unit comprising a transponder (T) and a sensor (S) according to an exemplary embodiment of the present invention;

FIG. 1b is a schematic depiction of a sensor-transponder unit comprising one sensor and two transponders according to an exemplary embodiment of the present invention;

FIG. 2 is a schematic depiction of a sensor-transponder unit comprising one transponder and two sensors according to an exemplary embodiment of the present invention;

FIG. 3 is a schematic depiction of a sensor-transponder unit comprising four sensors (S) and four transponders (T) according to an exemplary embodiment of the present invention;

FIG. 4 is a schematic depiction of a transportation process of a container, including a temperature profile according to an exemplary embodiment of the present invention;

FIG. 5 is a schematic depiction showing the integration of the transportation process shown in FIG. 4 into a monitoring system (Shipment Control & Management—SCM) according to an exemplary embodiment of the present invention;

FIG. 6 is a perspective view of a container showing the manual acquisition of data from a transponder 600 that is located on a container 601, by a reading device 602 in accordance with an exemplary embodiment of the present invention;

FIG. 7a is a perspective view of a container in which a sensor 701 is configured as a sensor surface and is located among objects 702, 703, 704 and 705 in the interior of a container 706 in accordance with an exemplary embodiment of the present invention;

FIG. 7b is a perspective view of a container in which a sensor strip 801 is located among objects 802, 803, 804, 805, 806, 807 in the interior of a container 808 in accordance with an exemplary embodiment of the present invention;

FIG. 8a is a perspective view of a container in which circular sensors are arranged in the interior of the container in accordance with an exemplary embodiment of the present invention;

FIG. 8b is a perspective view of an alternative container in which circular sensors are arranged in the interior of the container in accordance with an exemplary embodiment of the present invention;

FIG. 9 is a cross-section view through a transportation container according to an exemplary embodiment of the present invention, with several sensors and transponders;

FIG. 10 is a perspective view of a container according to an exemplary embodiment of the present invention;

FIG. 11 is a perspective view of a container according to an exemplary embodiment of the present invention in which a sensor is located in the area of the objects and is in communication with a transponder arranged outside of the interior of the container, and

FIG. 12 is a diagram showing strips arranged next to each other in order to illustrate practical length differences among various sensor-transponder combinations in accordance with an exemplary embodiment of the present invention.

### DETAILED DESCRIPTION OF SPECIFIC EMBODIMENTS

An exemplary embodiment of the present invention comprises a wide array of combinations of sensors and transponders.

Thus, for example, it is possible to use several identical sensors in order to achieve a two-dimensional or three-dimensional detection of measured variables, for example, to create a temperature image.

Moreover, it is preferred to use several different types of sensors in order to detect different measured variables—for example, temperature, humidity or radiation exposure.

Moreover, it is advantageous for different transponders to be used. This allows operation with different operating conditions, especially different operating frequencies, for example, UHF, HF.

Furthermore, it is advantageous to provide several identical transponders in order to improve the reading quality and increase the reading rate. Such applications are advantageous especially when the reading of the data has to be carried out especially quickly and/or reliably.

For this purpose, it is advantageous to arrange the transponders in a suitable geometry, for example, in the form of a net, a ring or a mat.

The following are likewise comprised:

several identical sensors with one transponder;

several different sensors with one transponder;

several identical transponders with several identical sensors;

several identical transponders with several different sensors;

several different transponders with several different sensors;

several different transponders with several identical sensors.

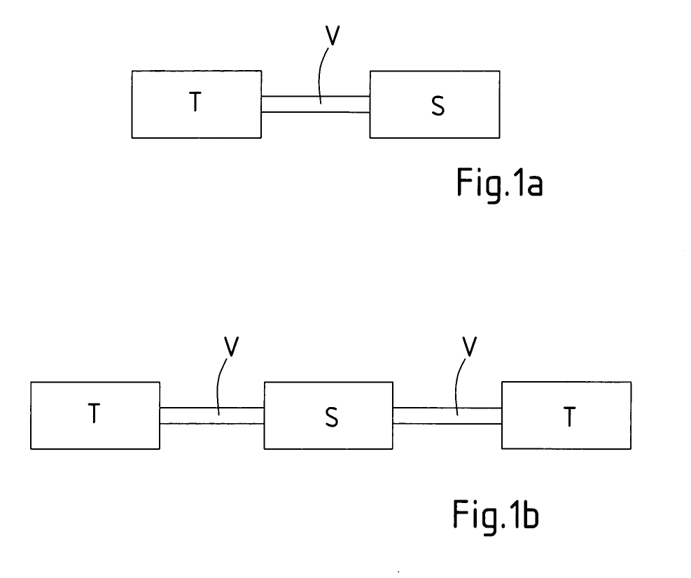

FIGS. 1a, 1b, 2 and 3 schematically show sensor-transponder units according to an exemplary embodiment of the present invention.

These figures show examples of a connection between sensors and transponders by connection structures V. The connection structures V can be configured in multifaceted ways. For example, these are elements to relay signals. Preferably, the connection structures are configured in such a way that they also allow mechanical contact between transponders and sensors.

For this purpose, it is advantageous for the connection structures to be flexible.

In order to allow an adaptation of the connection structures to geometric requirements, it is especially advantageous to configure said connection structures as strips.

Thanks to their strip-like configuration, the connection structures can especially be more readily incorporated into containers for the shipment of objects.

In an exemplary embodiment of the invention, it is provided that at least individual sensor-transponder units are already integrated into the containers during the production process of said containers. This is done, for example, in that blanks made of a folding material and provided for the production of a box are connected to the sensor-transponder units. Here, it is especially advantageous to first make the connection with the sensor-transponder units and then to fold the blanks into the desired shape to form the container.

However, it is likewise possible to first make or provide the containers and to subsequently equip them with the sensor-transponder units according to an exemplary embodiment of the present invention.

Of course, before the final production of the container, a first sensor-transponder unit can be incorporated into the areas intended for the production of the container and, after the production of the container—if desired at a much later point in time—it can be provided with a second sensor-transponder unit.

In particular, it is advantageous to incorporate at least one sensor of a sensor-transponder unit into the container while said container is being filled. This has the advantage that the sensor can be brought into contact with at least some of the objects.

When a temperature sensor is used, it is especially advantageous for it to be in contact with at least one object, at least in some places. This ensures that the sensor has the same temperature as the objects that are to be monitored.

The number of sensors and transponders is adapted to the requirements of the monitoring that is to be carried out.

Thanks to a strip-like configuration, the connection structures can be more conveniently incorporated into containers for the shipment of objects.

The connection structures V are preferably between 5 cm and 1 meter in length, preferably between 10 cm and 80 cm.

The connection structures V bring about a thermal insulation between the sensor S and the transponder T. In order to further improve the insulation, it is advantageous for the connection element to comprise a thermally insulating material.

FIG. 1 shows a schematic depiction of a sensor-transponder unit consisting of a transponder (T) and a sensor (S) according to an exemplary embodiment of the present invention.

By the same token, it is possible to connect one sensor to several transponders.

For example, FIG. 1b shows a schematic depiction of a sensor-transponder unit consisting of one sensor and two transponders according to an exemplary embodiment of the present invention.

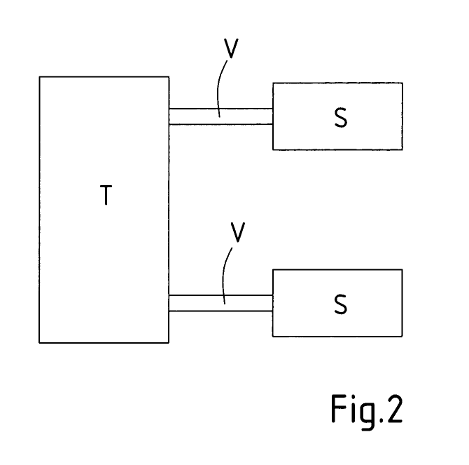

By the same token, it is possible to connect one transponder to several sensors. For example, FIG. 2 shows a schematic depiction of a sensor-transponder unit consisting of one transponder and two sensors according to an exemplary embodiment of the present invention.

The monitoring capability is improved by using several sensors.

By using several transponders, it is possible to carry out reading procedures for status information more quickly and/or reliably.

In each case, the sensors and transponders are advantageously arranged as a function of the requirements (close to the objects to be monitored or to the outside contact sites that are likewise to be monitored).

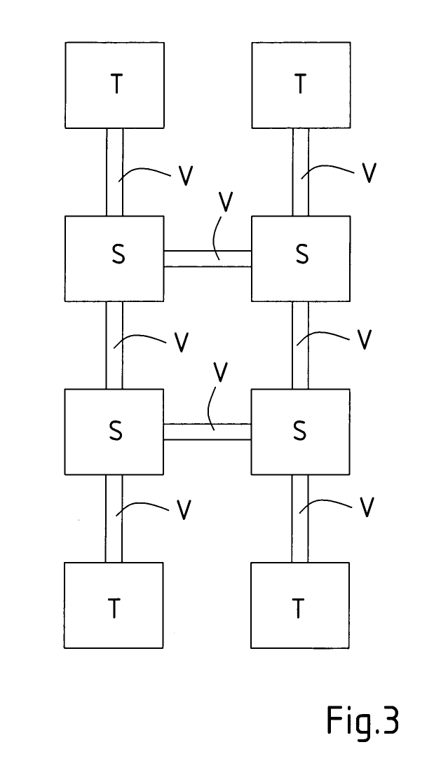

In this context, FIG. 3 shows a sensor-transponder unit consisting of four sensors (S) and four transponders (T) according to an exemplary embodiment of the present invention.

The sensor-transponder units depicted can be used in a wide variety of areas of application.

Thus, it is possible to use them in a wide variety of application areas, for example, in medical technology or in merchandise security systems.

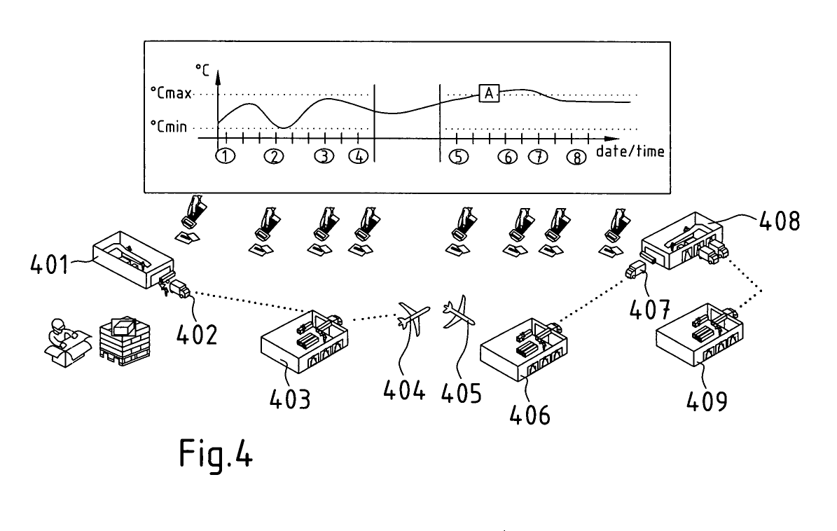

The use of the sensor-transponder unit in logistics systems is described below with reference to FIGS. 4 through 12 as an exemplary embodiment of the invention.

The logistics chain shown in FIGS. 4 through 12 makes it possible to transport objects that have to remain refrigerated over any desired distance, for example, even transcontinentally.

FIG. 4 is a schematic depiction of a transportation process of a container equipped with a sensor-transponder unit. This figure also shows a depiction of a temperature profile determined during the transportation process.

The person skilled in the art of logistics will be aware of the fact that the temperature is but one possible parameter of the transportation that needs to be secured.

In particular, of course, instead of and/or in addition to the temperature, it is likewise possible to check and monitor other variables that are necessary to ensure the product quality of the objects, and to make sure that they are observed.

Examples of other parameters that might need to be monitored and observed are the humidity and/or the effects of impacts.

The measures according to the invention make it possible to achieve the following objectives:

ensuring the product integrity of the objects;

quality management;

compliance with statutory requirements;

initiation of corrective measures in order to avoid damage to the object;

initiation of preventive measures in order to avoid damage to the object and

process control as well as process optimization.

An exemplary embodiment of the invention provides for calculating an anticipated duration of utilization of the objects.

In particular, sensor RFID units are used according to an exemplary embodiment of the present invention that monitor temperature distribution and that determine an overall effect on the objects.

Here, the term overall effect preferably refers to the weighting of instances of exceeding the temperature and times when excess temperatures occurred.

In an exemplary embodiment, a calculation of the overall effect on the object or objects is possible by means of a computing unit in the containers.

However, it is likewise possible and advantageous to carry out the calculation in a data processing unit that is in communication with the reading unit.

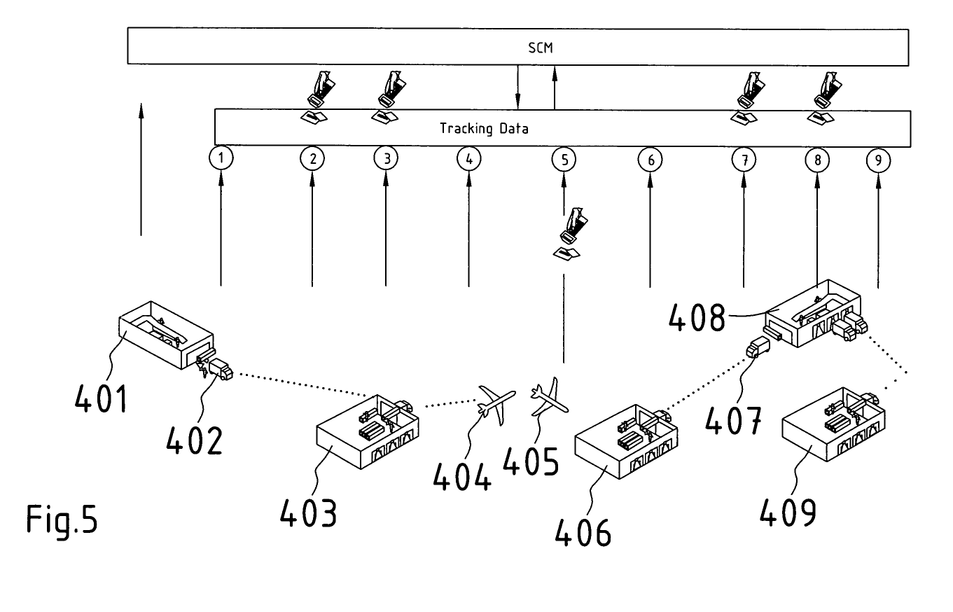

FIG. 5 shows an integration of the transportation process shown in FIG. 4 into a monitoring system (Shipment Control & Management—SCM).

FIGS. 4 and 5 show that values are measured and status information (measured values or values derived from them) is transmitted in various processing steps of a transportation chain.

A first measurement of properties of the physical objects—for example, a temperature measurement—is carried out in a method step 1 when the containers are accepted by a dispatching warehouse (sending location) 401—optionally when they are being loaded into a transport vehicle 402.

In another method step 2—for example, during the transportation of the shipment from the dispatching warehouse 401 to a warehouse 403, for example, a freight terminal of an airport—at least one more measurement and/or acquisition of shipment-relevant data is carried out, for example, information that is relevant for customs processing.

In a method step 3 of a handling procedure in the warehouse 403, another measurement and/or acquisition of additional shipping-relevant information is carried out, for example, about the duration of the shipment so far.

In a method step 4, information is transmitted from the containers to the reading unit and/or from the reading unit to an evaluation unit. Here, for example, the previously acquired customs-relevant information and/or the acquired measured values—especially temperature values or temperature effects on the objects derived from said measured values—are transmitted.

Such a procedure can be carried out, for example, during the transportation of the containers—for example, in an airplane. In the case shown here, a transmission is shown during the starting phase of an airplane 404.

In a method step 5, for example, another temperature measurement is made and/or an expected arrival time at a destination airport is transmitted.

In a method step 6, a measuring procedure is carried out while the container is being transported.

After transportation to the destination airport, the containers are transported to another warehouse 406—for example, a freight terminal.

In addition to the presented measurements at the detection points, it is advantageous to carry out further measurements as set forth in the method steps 1 to 9.

Such additional measurements between the individual method steps are shown in the time scale between the various method steps depicted in FIG. 4 by vertical lines on the horizontal coordinate axis.

This makes it possible, for example, to promptly detect the exceeding of a set point that triggers an alarm—for example, when a higher temperature than permissible is reached.

Advantageously, based on models about temperature effects, it is ascertained whether the exceeding of the temperature leads to an impairment of the product quality or whether this merely shortens the shelf life.

In case of serious damage to the objects, they are diverted from the production sequence.

In those cases where only the shelf life of the products has been shortened, then the previously determined shortened shelf life is recorded and logistical information is registered about the use of the object within the newly calculated shelf life period.

In order to ensure this, in a method step 7—for example, at an interim storage facility 408 of an operator of a logistics system—it is advantageous to record the ascertained temperature values and/or impairment factors derived from this or else a temperature profile and to transmit them to an evaluation unit.

Preferably, at the latest before any further transportation of the shipment from the interim storage facility 408 to a receiving location 409, the received data is transmitted to the intended receiving location in a method step 8.

In another method step 9, the acquired measured data is augmented by another measuring procedure.

Moreover, it is advantageous to transmit a confirmation of the delivery and of the transmission of the status information (measured values and/or information derived from them).

Containers that are especially suitable for carrying out the method will be presented below.

Preferably, the containers are structured in such a way that they have an outer box and an inner box, whereby it is advantageous to provide materials between the outer box and the inner box in order to prevent the object or objects from being affected.

In cases where additional security is desired in order to prevent the temperature from being exceeded, it is advantageous to place at least one cooling element into the container along with the object or objects.

Especially reliable measured values are obtained in that at least one of the sensors is located in the interior of the container near the object or objects—preferably in contact with at least one object.

Furthermore, it is advantageous to arrange additional sensors, for example, on the inner wall of the inner box and/or on the cooling element.

As a result, it is possible to determine a temperature curve and/or to determine predictive values for the anticipated temperatures of the sample on the basis of temperature changes that have occurred—for example, at one or more positions of the container, for example, on the inner wall of the inner box of the container and/or of the cooling element.

A determination of predictive values for the anticipated temperature or temperatures—if the transportation of the containers remains unchanged—means that the risk of exceeding a critical temperature can be recognized ahead of time.

In an exemplary embodiment of the invention, the temperature is prevented from being exceeded in that at least one transportation parameter is changed.

For example, in case of an impending impairment of the cooling, transport in a faster means of transportation—for example, a helicopter instead of a truck—can prevent an interruption of the cold chain (exceeding a specified temperature—especially over a longer period of time than permitted on the basis of the product files). As an alternative, for example, a transport in a vehicle with refrigeration or freezer equipment can be selected.

Whereas no special requirements have to be made of the closure of the inner box, the attachment of the flaps of the outer box has to ensure a secure closure. This is advantageously achieved by gluing.

In order to offer the user of the containers the most convenient possible use of the containers according to an exemplary embodiment of the present invention, the closure structures can already be present in the optionally folded container when it is supplied. They can be placed inside the container, for example, together with a preprinted address sticker and/or instructions for use, and can advantageously be fastened so as to be detachable. The address sticker, once it has been filled in, can be affixed in a possibly marked area. Furthermore, instructions for using the box, printed advertising, postage indicia or other imprints can be present on the container.

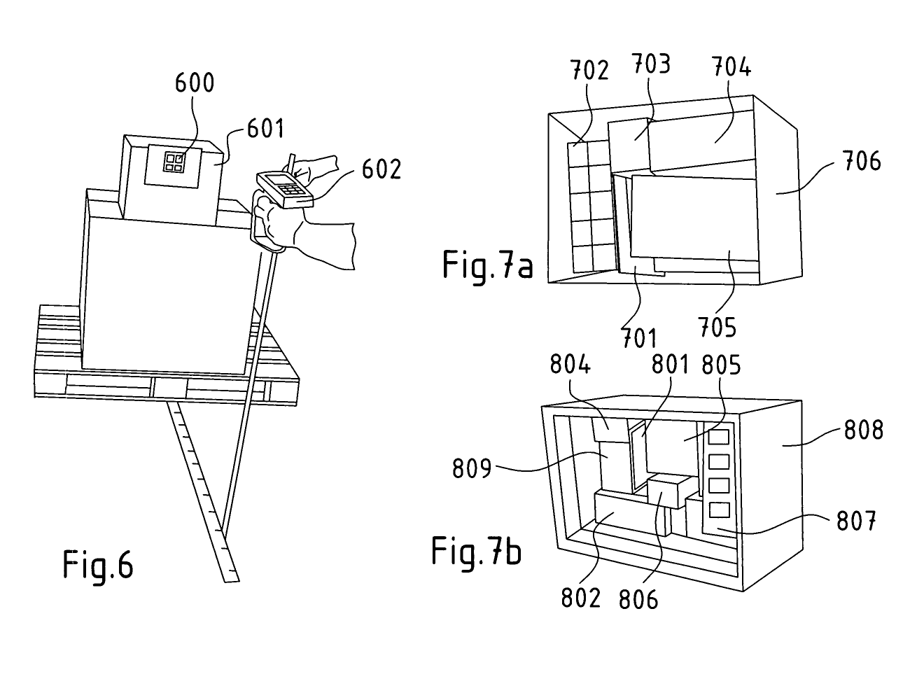

FIG. 6 shows the manual detection of data from a transponder 600 that is located on a container 601, by a reading device 602.

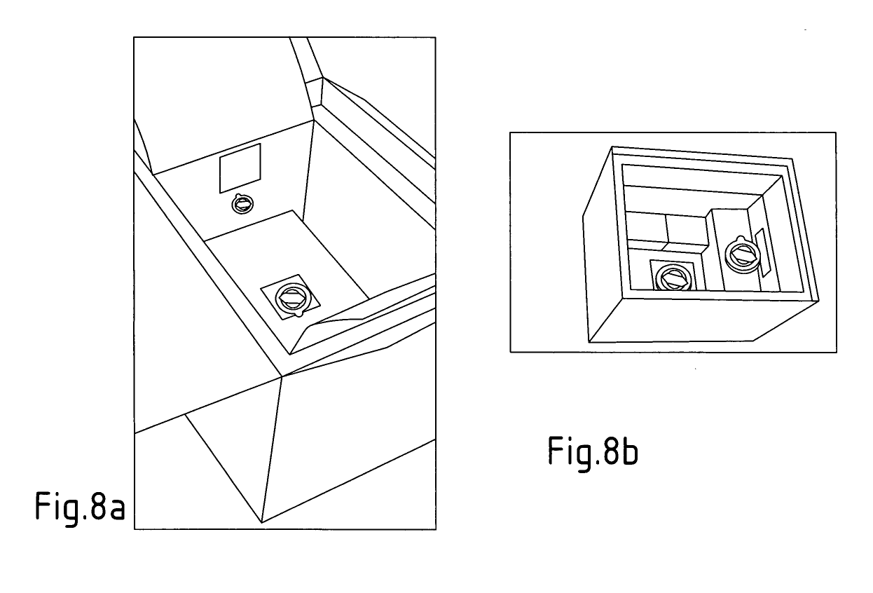

FIG. 7a shows an exemplary embodiment of a container in which a sensor 701 is configured as a sensor surface and is located among objects 702, 703, 704 and 705 in the interior of a container 706.

FIG. 7b shows an exemplary embodiment of a container in which a sensor strip 801 is located among objects 802, 803, 804, 805, 806, 807 in the interior of a container 808.

FIG. 8a shows an exemplary embodiment of a container in which circular sensors are arranged in the interior of the container.

FIG. 8b shows an exemplary embodiment of a container in which circular sensors are arranged in the interior of the container.

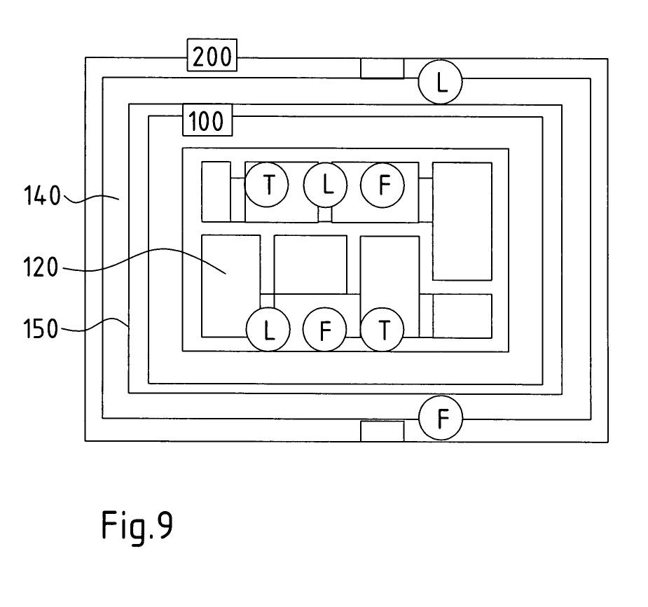

FIG. 9 is a cross-section view through a transportation container according to an exemplary embodiment of the present invention, with several sensors and transponders. The cross section shows that the side walls 121, 122, 123 and 124 of the inner box are parallel to the side walls 111, 112, 113 and 114 of the outer box. In this exemplary embodiment, the walls of the inner and outer boxes are made of cardboard having a certain thickness, of the type commonly used for packaging.

The blank of the outer box can be made in one piece, consisting, for example, of four parallel side walls 111, 112, 113 and 114 next to each other and an adjacent tab 160 that is joined to the side wall 111. The tab 160 can extend over the entire length of the container, or there can be several smaller tabs that are distributed over the length of the container. The inner box can be formed analogously by four side walls 121, 122, 123 and 124 as well as by one or more tabs 170. Instead of the tabs 160 and 170, other types of connections can also be used.

The inner box can likewise be attached to the side walls of the outer box in various ways. It has proven to be especially advantageous to provide at least one tab 250 on at least one edge 150 of the inner box for purposes of attaching it to the outer box. Preferably, the tabs are located on two opposite edges 50 of the inner box. The tabs 250 can be made in various ways. It has proven to be especially advantageous to stamp the tabs out of the side walls of the inner box, preferably in a U-shape, so that they can be folded over a remaining folding line 180 in the direction of the arrow relative to the outer box. One or more connection tabs can be provided for each of the side walls of the outer box, distributed over the length of the container.

All of the tabs and side walls are advantageously affixed to each other by gluing but other types of connections are also conceivable. For example, staples or else tabs that engage into corresponding recesses can be used.

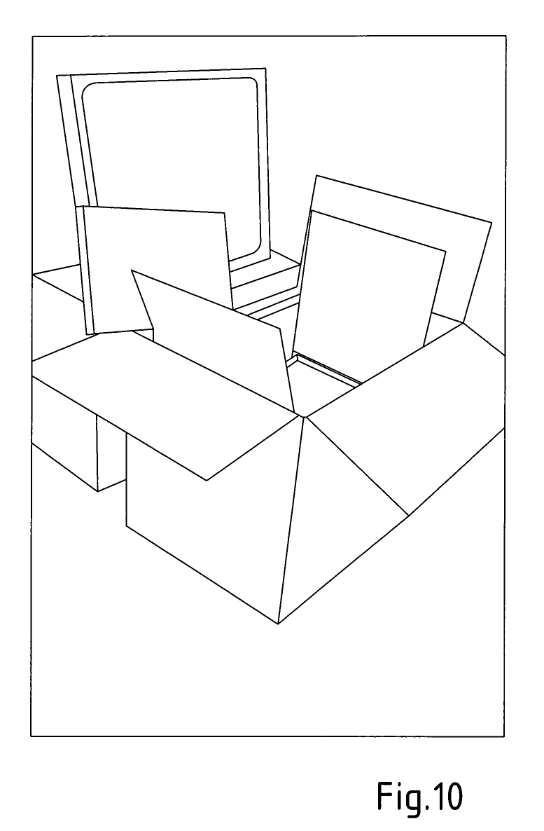

FIG. 10 shows a perspective view of a container according to an exemplary embodiment of the present invention.

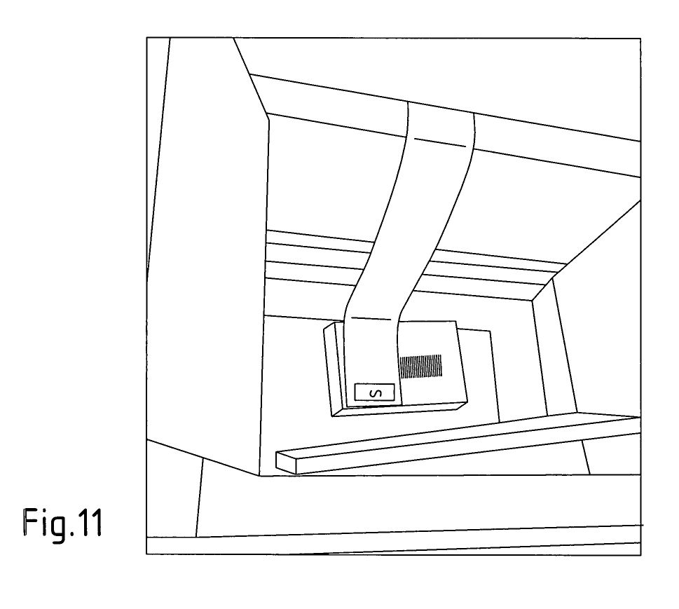

FIG. 11 shows a container according to an exemplary embodiment of the present invention in which a sensor is located in the area of the objects and connected to a transponder located outside of the interior of the container.

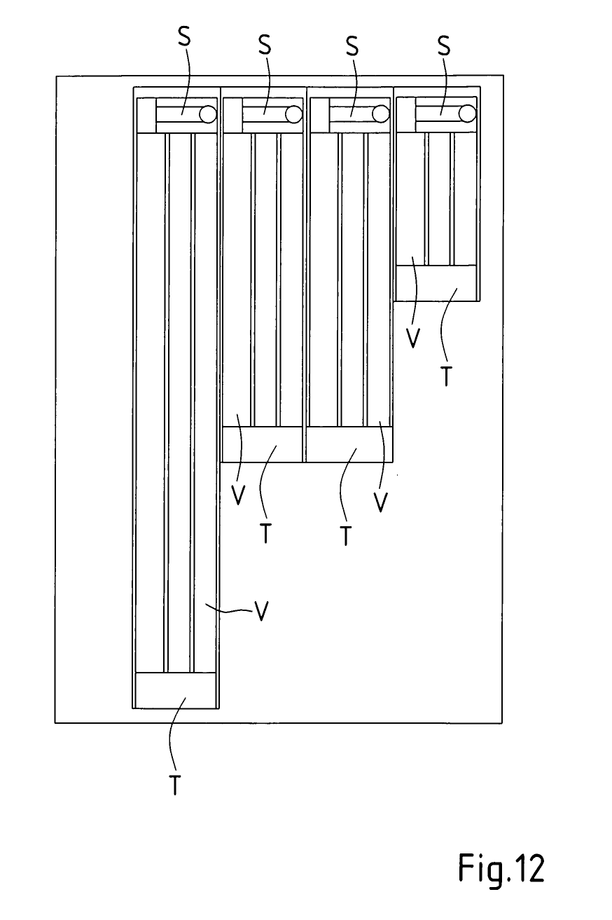

FIG. 12 shows strips arranged next to each other in order to illustrate advantageous length differences between various sensor-transponder combinations.

An especially preferred Radio Frequency Identification (RFID) allows an automated identification (radio identification) and localization of objects.

In an exemplary embodiment, an RFID system comprises the following:

transponders (also called RFID tag, smart tag, smart label or RFID chip);

reading devices with associated antenna (also called readers), and

integration with servers, services and other systems (middleware).

Although transponders that take up little or no storage space are especially advantageous, it is likewise possible to use transponders that store data.

The data is preferably read contact-free and without visual contact.

Transponders without data storage are preferred.

It is especially advantageous to acquire data—to perform measurements—in response to a request.

The data is transmitted between the transponder and the reading device by electromagnetic waves. At low frequencies, this is done inductively via a near field and, at higher frequencies, via an electromagnetic far field.

RFID tags can have a re-writable memory in which information can be stored during its service life.

The other characteristic parameters such as, for example, radio frequency, transmission rate, service life, cost per unit, storage capacity, reading range and functional scope also differ, depending on the area of application.

In principle, RFID communication functions as follows: the reader generates a high-frequency electromagnetic alternating field that is received by the antenna of the RFID tag. Induction current is formed in the antenna coil as soon as it approaches the electromagnetic field. This activates the microchip in the RFID tag. In the case of passive tags, the induced current also charges a capacitor that constitutes a permanent source of energy for the chip. In active tags, this is done by a built-in battery.

Once the microchip has been activated, it receives commands that the reader modulates in its magnetic field. Since the tag modulates an answer into the field emitted by the reader, it transmits its serial number or other data requested by the reader.

In this process, the tag itself does not emit a field but rather only changes the electromagnetic field of the reader. Here, the HF tags at 13.56 MHz differ from the UHF tags at 865-869 MHz (European frequencies).

HF tags use load modulation, that is to say, they consume the energy of the magnetic alternating field by means of short-circuiting. This can be detected by the reader. Through the link to the magnetic alternating field, this technology functions exclusively in the near field. Therefore, the antennas of a near-field tag constitute a coil.

UHF tags, on the other hand, use the electromagnetic far field to transmit the response. This embodiment of the method according to an exemplary embodiment of the present invention is called backscattering. Here, the electromagnetic wave is either absorbed or reflected with the largest possible backscattering cross section. The antennas are usually dipoles; the chip is located in the center of the RFID tag.

Since metal reflects this radiation very strongly, it impairs the reading procedure.

Moreover, certain substrate materials ‘detune’ the resonance frequency of the tag, which is why it is provided that the tags are adapted to the materials. Modern printers that are capable of printing on RFID tags and, at the same time, writing on them, can later—depending on the product—cut perforations into the antennas so that the antennas are optimally adapted to the materials that are to be glued on.

Since the energy supply of the microchip has to be continuously ensured in both methods (a commercially available UHF tag with a Philips chip according to the EPC 1.19 Standard requires a current of about 0.35 microamperes for the chip), the reader has to generate an enduring field. In the UHF area, this is called a “continuous wave” (CW). In view of the fact that the field strength decreases quadratically with the distance and this distance has to be traversed in both directions—from the reader to the tag and back—this continuous wave has to be quite powerful. Normally, between 0.5 and 2 watts of equivalent isotropically radiated power (EIRP) are used here.

In order to read out the tags, in the UHF range, several, for example, 10, free channels are available with a power of, for instance, 2 watts, above one channel and below three channels that can only be operated at a lower power. All of the channels extend over a width of 200 kHz. The tag response is given by the modulation of the response signal at 200 kHz to the continuous wave, as a result of which a sideband is formed 200 kHz above and below this continuous wave, hence, it is precisely in an adjacent channel.

In order to be able to simultaneously use as many RFID readers as possible in an environment, one strives to use the entire spectrum of the channels to the extent possible. A frequently used variant is to assign the channels 1, 4, 7 and 10 to the reader. Then, channels 0, 2, 3, 5, 6, 8, 9 and 11 would be available for the sidebands, whereby channel 0 and 11 may only be operated at a lower power, but this is not a problem since here only the tag response is transmitted and not a continuous wave.

Moreover, problems can arise if the RFID tag is located directly on the product. In order to solve this problem, it is advantageous to use flap or flag tags that project at a right angle away from the product and are thus at a great distance from the product.

The decisive factors for the size of the transponder are the antenna and the housing. The shape and size of the antenna depends on the frequency or wavelength. Depending on the required application, transponders are offered in various shapes, sizes and protection classes.

RFID tags, depending on the area of application, can even be as large as books (e.g. in sea-going freight container logistics). However, it is advantageous to produce very small RFID tags that can easily be integrated into the containers. The range of passive transponders is dependent not only on the frequency but also to a decisive extent on the coil size.

Small battery-free RFID tags do not have their own source of energy and they have to obtain their supply voltage by means of induction from the radio signals of the reading units. This reduces the costs and the weight of the chips but, at the same time, also diminishes their range. This type of RFID tags is used, for example, for product authentication and/or for tracking and tracing, since here the costs per unit are the crucial aspect. RFID tags with their own source of energy achieve a considerably greater range and have a larger functional scope, but they are more laborious to manufacture.

Encoded information as control instruments for parcel logistics is incorporated into the transponders.

In particular, the transponders can contain consecutive numbering—optionally with a check digit—as well as other numbering and address information or other information that serves to classify the shipment or for advertising purposes.

Especially extensive data volumes can be incorporated into smart transponders.

RFID identification systems—“smart transponders”—make it possible to optimize the logistical processes.

Therefore, they are suitable for influencing—including controlling—flexible distribution systems for route-optimized handling of the shipments.

For the operation, especially for signal modulation, the RFID microchip has to be supplied with energy. Here, a distinction is made between two types of RFID tags:
1. Passive RFID tags obtain their energy for supplying the microchip from the radio waves they receive. With the antenna as the coil, a capacitor is charged by means of induction and it supplies the tag with energy. The range here is from a few millimeters to several centimeters.
2. Active RFID tags obtain the energy for supplying the microchip from a built-in battery. Normally, they are in the resting state or are not transmitting any information in order to prolong the service life of the source of energy. Only when a special activation signal is received is the transmitter activated. This allows a considerably larger range, which can amount to about 100 meters.

Frequency Ranges

The following frequency bands are advantageous for the envisaged use:
Low frequencies (LF, 30-500 kHz). These systems have a small range, function flawlessly in the most often used 64 bit read-only technology and are fast enough for most applications. In the case of larger data volumes, the transmission times are longer. LF transponders are inexpensive to purchase, can withstand high levels of humidity and moisture, they are compatible with the use of metal, and they are offered in a wide variety of shapes.
High frequencies (HF, 3-30 MHz). Short to medium range, medium transmission speed, medium to inexpensive price class. The so-called smart tags operate in this frequency range (usually 13.56 MHz).
Ultra-high frequencies (UHF, 850-95 MHz, 2.4-2.5 GHz, 5.8 GHz). Long range (3 to 6 meters for passive transponders, 30 meters or more for active transponders) and high reading speed. Low prices for passive transponders, a tendency towards high prices for active transponders. Typical frequencies are 433 MHz, 868 MHz (Europe), 915 MHz (U.S.A.), 950 MHz (Japan) and in the 2.45 GHz and 5.8 GHz microwave ranges.

Most RFID tags send their information in plain text, but a few models also have the capability to transmit their data in encrypted form.

Data Incorporation
1. The data record of the transponder is incorporated at the point in time when the chip is manufactured (consecutive number). This is especially preferred for identification purposes and calls for less manufacturing effort and lower energy consumption.
2. Writable transponders:
EEPROM (electrically erasable programmable read-only memory) inductively coupled RFID;
FRAM (ferromagnetic random access memory);
SRAM (static random access memory)—requires an interruption-free source of energy.

Energy Supply
1. Passive transponders—energy supply is obtained from the (electrical/magnetic) field;
2. Semi-passive transponders, (back-up) battery for the use of connected sensors, but not for data transmission;
3. Active transponders—battery in normal case for the expansion of the range of the data transfer, but also for parallel sensor systems.

It is especially advantageous to use RFID tags that have at least one sensor input.

For example, an RFID tag with one or more sensor inputs will modify the one label data word bitstream that is read by a label query-1-recognition device.

An RFID tag can have a sensor input that is capable of receiving variable signals from one or more sensors, an analog variable or a digital variable.

The amplitude of the RFID tag modulates the CW-HF carrier of the HF generator with its data word bitstream by charging and discharging the resonance circuit or antenna of the RFID tag in accordance with the binary values of this data word bitstream.

The data word bitstream is a series of ON-OFF pulses that constitute, for example, a serial data word synchronization head and the RFID tag number.

Parity bits or a checksum value can likewise be contained in the data word bitstream. These series of ON-OFF pulses are detected by a label-reading device (query device), and the amplitude changes of its CW-HF signal are ascertained. These amplitude changes are caused by the electromagnetically coupled or HF-antenna-coupled RFID tag, which charges and discharges the resonance circuit or antenna of the label-reading device or query device.

In a refinement of an exemplary embodiment of the present invention, an RFID tag has a digital input for detecting a change in the voltage, in the current or in the resistance of a sensor connected to the digital input. The sensor state of the digital input can ascertain whether the bit values of the data word bitstream can be inverted. The difference between the two data word bitstreams yields the change in the sensor (open or closed), as a result of which a measured value is shown. The sensor can be supplied with voltage or current by an external source or by the RFID tag itself, which then feeds part of the current of the electromagnetically coupled or HF-antenna-coupled continuous wave of the query device or label-reading device.

The sensor can be, for example, an electromechanical switch, a transistor, a Hall-effect element, or a phototransistor.

Another exemplary embodiment of the RFID tag has an analog input for detecting an analog sensor signal that is represented by a variable voltage, current or resistance value.

The analog input can be converted by a voltage comparator into an ON-OFF high-low representation.

The voltage or current for supplying one or more analog sensors can be drawn from an external source or from the RFID tag, which uses part of the energy from the electromagnetically coupled or HF-antenna-coupled continuous wave from the query device or label-reading device. The analog sensor or sensors can be an RTD (resistance temperature detector), a thermoelement, a piezoelectric pressure measured-value transducer or the like.

The detected value can be, for example, the following: pressure, temperature, acceleration, vibration, moisture content, gas fraction, density, flow rate, sound intensity, radiation, magnetic flux, pH value, etc.

The voltage or current for supplying one or more sensors can be drawn from an external source or from the RFID tag, which then feeds part of the energy from the electromagnetically coupled or HF-antenna-coupled continuous wave from the query device or label-reading device.

The RFID tag can be made of a single semiconductor IC chip, or it can consist of several semiconductor single chips in an individual IC housing. It is likewise taken into account and falls within the scope of an exemplary embodiment of the invention that multiple module RFID tags with several discrete electronic modules are integrated into the above-mentioned embodiments, including, for example, microcontrollers, memories, digital logic circuits, analog circuits and discrete and/or monolithic measured-value transducers or sensors.

A refinement of an exemplary embodiment of the present invention comprises an RFID tag with a sensor input that causes logic circuits in the RFID tag to modify data contents.

If the RFID tag is passive, it has no internal current storage capability, and the current for its circuits comes from a near-field or far-field continuous wave high frequency (CW-HF) source. This is installed, for example, in a transportation system (for instance, a ground vehicle or aircraft) or in a warehouse.

When the RFID tag comes close to the CW-HF field, the RFID tag draws energy from the field by means of electromagnetic or HF-coupling.

The RFID tag located nearby influences the amplitude of the CW-HF carrier. The CW-HF generator has a query device that recognizes changes in the amplitude of the CW-HF carrier, and it has an evaluation circuit that, over a period of time, searches for one or more patterns in these amplitude changes. If a recognizable pattern is ascertained, then this means that an RFID tag was discovered, and the information in this recognizable pattern can be used.

The RFID tag can also supply the sensor with electric current.

The RFID tag generates a data word bitstream that is read by a query device or by a label-reading device. The data word bitstream contains information that is influenced by a signal value of the sensor. If the signal value of the sensor changes, then the information of the data word bitstream also changes.

The sensor or sensors can be digital or analog, as described above.

The reading unit (query device or label-reading device) detects the amplitude changes or frequency changes of an electromagnetic signal brought about by the transponder or transponders and converts them into the serial data word bitstream.

Thus, an exemplary embodiment of the present invention provides for a system in which RFID tags are used in an especially advantageous manner such that they reliably give information about a status and/or a current location of at least one object.

RFID systems according to an exemplary embodiment of the present invention preferably do not transmit only identification and position data, but also temperature, moisture, shock-absorption, biometric and other data. This data can be recorded and evaluated.

Refinements of exemplary embodiments of the invention provide for transforming data into information and linking it with additional information from application systems.

Contact-free reading of many objects simultaneously and depicting logistics sequences in the software architecture helps to use acquired real-time information to improve the logistics processes (processing, handling and/or transportation processes in the logistics system).

The tracking capability employing RFID technology helps to improve the security thanks to optimized transportation processes.

The RFID technology according to an exemplary embodiment of the present invention makes it possible to depict a worldwide logistics chain in real-time and to provide information about the current location, status, origination and destination location as well as, if applicable, also sensor data.

The handling of sensitive objects can be detected by sensor systems in a timely fashion and can be tracked precisely with respect to the position and the point in time.

The logistical sequences are configured so as to be automated and secure, making use of RFID identification, temperature and humidity measurement as well as the integration of incoming inspections. For this purpose, it is advantageous for all of the relevant information to be processed by means of real-time processes. Among other things, the following partial processes are involved:
arrival of the object,
transportation to/from interim storage facilities,
placement into and removal from interim storage facilities,
real-time monitoring of the movements (combination of identification and reading zones).

Monitored information comprises, among other things:
container identification (unambiguously encoded serial numbers) per passive RFID tag (linking with the content data only after authorization and decoding).
ambient factors such as temperature and humidity. If the values exceed or fall below certain ranges over periods of time, for example, the classification of individual substances changes and so does the capability for further processing.
inventory monitoring in the interim storage facility:
   all tags are read within predefinable time intervals and/or upon request.

In individual exemplary embodiments of the invention, it is provided that only changes are detected. As an alternative, it is possible to store a data history.

An exemplary embodiment of the present invention makes it possible to use warning messages. The warning messages can be used to change logistical processes—especially the sorting, storage and/or transportation of the objects—or to initiate a new logistical process—for example, a new transportation process.

It is advantageous to use a server in order to control the system. A program serves to operate the server, and this program is preferably stored on a computer program product—for example, on a suitable storage medium.

In this manner, it is possible to link sensors and, if applicable, also actuators. Advantageously, filtering and, if applicable, correlating the measured data is carried out in real time so that the logistical processes can be directly influenced.

Data can be made available via various communication channels, for example, the data channels of the transponders, mobile communication systems (PLUTUS, GSM, GPRS, UMTS). This makes it possible to:
link the sensors and the actuators;
filter and correlate the sensor data in real time in the process context;
integrate the existing HMMS application;
provide the data and messages via different channels (hand-held device, telephone, portal, etc.).

The possibility of achieving real-time information using RFID tags and of integrating this information into the information architecture is the concept of the sensor-based services.

It is especially advantageous to store status information received by the reading devices and/or to transmit it to the data processing unit (server).

Advantageously, the ascertained status information is compared to specified data. In this manner, it is possible to ascertain deviations and to quickly determine the extent to which there is a need to change the logistical processes.

Consequently, this especially makes it possible to promptly inform an intended recipient or the sender of the object about the transportation status.

In this manner, handling systems and/or transportation systems are capable of achieving an improved cooperation that, with the same information level, is location-independent and also capable of generating a suitable response on the basis of the sensor information obtained.

As a result, the logistical processes can be carried out more quickly and reliably.

### LIST OF REFERENCE NUMERALS

1 to 9 method steps
10 container
11 lid surface
12 capacitive element
20 object
21 RFID tag, identification device
30 sensor, electrically conductive layer/strip
40 data processing unit
50 position-finding device
60 monitoring center
61 message-receiving means, message-receiving device
70 atmosphere measuring device
80 communication module, interface
90 object detection device, edge antenna
100 protective covering
110 pallet bottom
111 to 114 side walls
121 to 124 side walls
150 edge
160 tab
170 tab
180 folding line
250 tab
401 sending location
402 transport vehicle
403 warehouse
404 airplane
405 method step
406 warehouse
408 interim storage facility
409 receiving location
600 transponder
601 container
602 reading device
701 sensor
702 to 705 objects
706 container
801 sensor strips
802 to 807 objects
808 container

1-21. (canceled)

22. A sensor-transponder unit, comprising:
a sensor;
a transponder connected to the sensor by a connection element, the sensor and the transponder being configured as components that are physically separated from each other; and
an interlayer that absorbs or reflects electromagnetic radiation arranged between the sensor and the transponder.

23. The sensor-transponder unit recited in claim 22, wherein the transponder and the sensor are located in two housings that are separate from each other.

24. The sensor-transponder unit recited in claim 22, wherein the sensor-transponder unit is adapted to be connected to a container that has an interior to hold at least one object.

25. The sensor-transponder unit recited in claim 24, wherein the sensor is located in the interior of the container.

26. The sensor-transponder unit recited in claim 24, wherein the transponder is arranged further to the outside of the container than the sensor is.

27. The sensor-transponder unit recited in claim 22, wherein the connection element comprises at least one cable.

28. The sensor-transponder unit recited in claim 22, wherein the connection element comprises an electromagnetic coupling.

29. The sensor-transponder unit recited in claim 22, wherein the sensor-transponder unit is adapted to be connected to a container that has an interior to hold at least one object, and wherein measured data about the object is acquired by the sensor, the measured data being transmitted to the transponder, and wherein status information about the object is transmitted by the transponder to a reading unit as a function of the measured data.

30. The sensor-transponder unit recited in claim 29, wherein the status information is stored.

31. The sensor-transponder unit recited in claim 29, wherein the status information is stored in a storage medium installed in the container.

32. The sensor-transponder unit recited in claim 22, wherein the connection element comprises at least one optical waveguide.

33. The sensor-transponder unit recited in claim 22, wherein the sensor-transponder unit is adapted to be connected to a container that has an interior to hold at least one object, and wherein the sensor is closer to the object than the transponder is.

34. A method for operating a sensor-transponder unit having a sensor and a transponder, and at least one interlayer that absorbs or reflects electromagnetic radiation arranged between the sensor and the transponder, the method comprising:
acquiring measured data via the sensor;
transmitting the measured data via a connection element to the transponder; and
transmitting status information from the transponder to a reading unit while influencing the measured data.

35. The method recited in claim 34, comprising supplying energy to the transponder.

36. The method recited in claim 34, comprising supplying energy to the transponder via the reading unit.

37. The method recited in claim 34, comprising:
supplying energy to the transponder; and
relaying the energy from the transponder to the sensor.

38. The method recited in claim 34, comprising establishing a signal line between the sensor and the transponder via the connection element.

39. A sensor-transponder unit, comprising:
means for acquiring measured data via a sensor;
means for transmitting the measured data to a transponder; and
means for transmitting status information from the transponder while influencing the measured data.
